(19) United States
(12) Patent Application Publication
(10) Pub. No.: US 2006/0230349 A1
(43) Pub. Date: Oct. 12, 2006

(54) Coalesced per-file device synchronization status

(75) Inventors: Michael Novak, Redmond, WA (US); Kipley J. Olson, Mercer Island, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/099,723

(22) Filed: Apr. 6, 2005

(51) Int. Cl. G06F 3/00

(52) U.S. Cl. 715/700

(57) ABSTRACT

Methods for reporting status information in a user interface and managing synchronizations. One or more categories of status information are defined in connection with synchronization operations performed on digital files. Upon termination of a synchronization operation, per-file status information for the terminated synchronization operation is categorized in one of the defined categories. The defined categories having per-file status information categorized therein are displayed with a summary of the per-file status information. In one aspect, an expandable node corresponding to each of the defined categories of status information that have per-file status information categorized therein is displayed. Grouping the digital files according to the defined categories of status information, permits collectively managing the digital files.

### TECHNICAL FIELD

Embodiments of the present invention relate to the field of processing digital media content. In particular, embodiments of the invention relate to managing status information for per-file synchronization of user-configurable device storage.

### BACKGROUND OF THE INVENTION

As digital media technology improves and the price of storage decreases, users increasingly host collections of digital media on their personal computers. But users often desire for their digital media collections to be portable. More and more, users seek to transfer (i.e., move or copy) all or some of their collections to portable client devices. Digital media includes, for example, music, images, videos, and the like.

Users transfer media content from personal computers to a variety of other devices including other personal computers and portable consumer electronic media devices. Examples of portable devices include Personal Media Players (e.g., MP3 players), Personal Digital Assistants (PDAs), cell phones, notebook or laptop computers, and other portable client devices. Transferring at least part of a digital media collection to a portable device allows a user to enjoy media away from his or her main personal computer.

With the advent of relatively high capacity storage on portable client devices, users can store large numbers of media files on their devices. But filling such a device with a meaningful subset of a user's digital media collection can be a laborious task. FIG. 1 shows an example of a conventional user interface (UI) for providing status information to a user regarding the transfer of files to a device. Typically, transferring files to a portable client device or the like, often in the context of synchronization, is a per-item process. In other words, where a batch of content is selected for transfer, each item is transferred one-by-one. Conventional UI displays reporting synchronization status involve showing the progress of each file individually and, if there is an error, showing the appropriate error or other message alongside the name of the file to indicate the status of the transfer. Commonly used status indicators include, for example, Queued for Transfer; Transferring; Transcoding; Error: XXXXXX; Insufficient Space on Device; and Removed from Device.

Referring further to FIG. 1, an initial state is illustrated at 102 as a typical flat array of status information before files are transferred from one device to another. While transferring the files, the conventional UI, as shown at 104, updates the status information on a per-file basis. In other words, the prior art teaches displaying such information in a flat list of items and corresponding status information. For example, the UI at 104 reports on the completed processing of Tracks 1-5 and the current processing of Track 6. With a relatively small set of files, this user experience may be acceptable to obtain an overall sense of what worked and what did not work in the file transfer. But manually scanning a large list such as typically found with today's large capacity devices is extremely tedious and the user risks overlooking important information buried in the list.

In the example of FIG. 1, status information for only seven media files is shown. It should be readily apparent to those skilled in the art, however, that per-file status information for large numbers of files can be very difficult to manage. So, for example, if the user transferred 1000 files, presently available approaches for reporting synchronization status information would require the user to scroll through all 1000 items to check for those having a failed status indicator to see if there were any problems. Moreover, the user would be required to handle each problem separately.

In the alternative, it is also known to merely display a general message such as, “Device is Synchronizing.” Although very simple, such a user interface provides very little, if any, useful information regarding the status of the transfer of many files from one device to another.

In light of the foregoing, improvements in reporting synchronization status are desired to provide a “rolled up” status for items as they are processed.

### SUMMARY OF THE INVENTION

Embodiments of the invention overcome one or more deficiencies in the prior art by permitting coalesced per-file device synchronization status. According to aspects of the invention, a user interface groups status information for items as they are processed. In one embodiment, information for each file is placed under a common entry according to the status of the transfer. The user may view individual items for any particular “bucket” or group or node by expanding the contents of the bucket. These aspects of the present invention enable the user to manage and “bulk fix” content experiencing similar problems. Additionally, reporting of synchronization status information according to aspects of the invention allows providers of content, services, and the like to target services offered to the user. For example, when a user attempts to transfer content that is not licensed for transfer, the error message may include a link for buying additional copies or upgrading the user's service level for the entire group of items.

Briefly described a method embodying aspects of the invention reports status information in a user interface. The status information relates to a synchronization between a source device and a target device. The synchronization includes one or more operations performed on each of a plurality of selected digital files being synchronized. The method includes defining one or more categories of status information in connection with the synchronization operations performed on the digital files and, upon termination of a synchronization operation performed on one of the digital files, categorizing per-file status information for the terminated synchronization operation in one of the defined categories. The method also includes displaying the defined categories having per-file status information categorized therein with a summary of the per-file status information.

Another aspect of the invention involves a computer system having a display and a selection device. In such a computer system, a method reports status information in a user interface presented on the display. The status information relates to a synchronization between a source device and a target device. The synchronization includes one or more operations that are performed on each of a plurality of selected digital files being synchronized. The method includes defining one or more categories of status information in connection with the synchronization operations performed on the digital files. The method also includes, upon termination of a synchronization operation performed on one of the digital files, categorizing per-file status information for the terminated synchronization operation in one of the defined categories and displaying an expandable node corresponding to each of the defined categories of status information that have per-file status information categorized therein. The node is responsive to the selection device for displaying the summary of the per-file status information when the node is collapsed and for displaying the per-file status information when the node is expanded.

In yet another aspect of the invention, a method manages a synchronization between a source device and a target device. The synchronization includes one or more operations performed on each of a plurality of selected digital files being synchronized. The method includes defining one or more categories of status information in connection with the synchronization operations performed on the digital files and, upon termination of a synchronization operation performed on one of the digital files, categorizing per-file status information for the terminated synchronization operation in one of the defined categories. The method also includes grouping the digital files according to the defined categories of status information and collectively managing the digital files based on the grouping.

Computer-readable media having computer-executable instructions for performing a method of managing applications embody further aspects of the invention.

Alternatively, embodiments of the invention may comprise various other methods and apparatuses.

Other features will be in part apparent and in part pointed out hereinafter.

### BRIEF DESCRIPTION OF THE DRAWINGS

FIG. 1 illustrates an exemplary user interface for reporting synchronization status according to the prior art.

FIG. 2 is a block diagram of an exemplary computer system in which the present invention may be used.

FIG. 3A, FIG. 3B, and FIG. 3C illustrates an exemplary user interface for reporting synchronization status according to aspects of the present invention.

FIG. 4 is a flow diagram illustrating an exemplary synchronization process according to aspects of the present invention.

FIG. 5 is a block diagram illustrating an exemplary embodiment of a suitable computing system environment in which one embodiment of the invention may be implemented.

Corresponding reference characters indicate corresponding parts throughout the drawings.

### DETAILED DESCRIPTION OF THE INVENTION

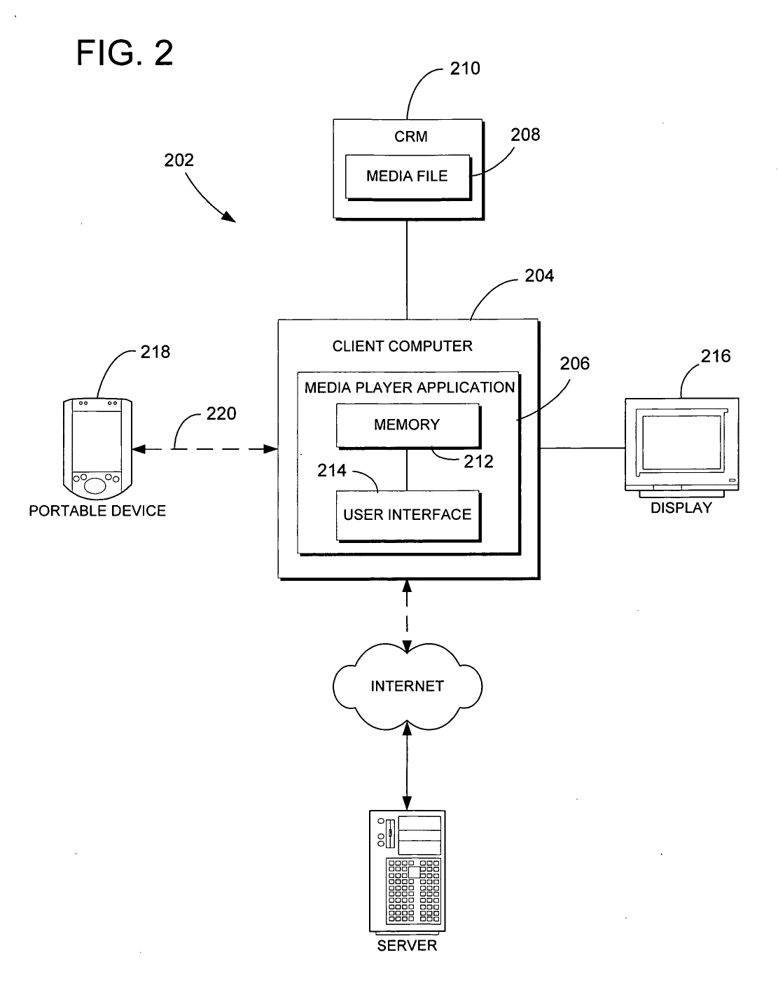

Referring now to the drawings, FIG. 2 illustrates an exemplary computer system 202 in which the present invention can be used. Aspects of the invention involve coalesced per-file device synchronization status. According to aspects of the invention, a user interface groups status information for items as they are processed. The system 202 includes a client computer 204 that executes a media player application (MPA) 206. The media player application 206 can be any suitable rendering filter or program that is configured to play digital media so that a user can experience the content embodied on the media. For example, a suitable MPA 206 includes a CD media player application, a digitally-compressed-file player application, and/or a DVD media player application. Executing MPA 206 in the illustrated embodiment, allows the user to access a digital media file 208 on a computer-readable medium (CRM) 210 such as a compact disc, hard drive, network server, or other suitable computer storage media. The MPA 206 also accesses, retrieves, stores, and displays metadata associated with the media file for the user, either directly from the file or from a remote metadata provider.

Those skilled in the art are familiar with metadata, which is simply information about data. In the context of the present invention, metadata involves information related to specific content of digital media file 208 being played via MPA 206. Basic metadata includes, for example, one or more of album title, artist, performer, genre, description of content, and the like. Extended or premium metadata includes album art, performer biographies, reviews, related performers, where to buy similar items, upcoming concerts, ticket sales, uniform resource locators for other related experiences including purchase opportunities, and the like.

The MPA 206 accesses a memory 212 for storing digital media files 208, and includes a graphical user interface 214 for displaying media files 208 and/or organized metadata to the user on a display 216. The UI 214 may also be used to assist the user in transferring media files 208 and organized metadata to a remote device such as a portable media device 218 communicatively connected to the computer 204.

According to embodiments of the invention, an exemplary portable media device 218 may be a media transfer protocol (MTP) device, a personal digital assistant (PDA), a smartphone device or cellular telephone, a mass storage device, a Moving Picture Experts Group audio layer-3 (MP3) player, an audio system in an automobile, a notebook, laptop, or tablet PC, or the like. Although the present invention is particularly well suited for transferring digital media files between a main device and a portable device, aspects of the invention may even be applied to transferring files between desktop personal computers. In general, such device 218 will have a suitable rendering filter or media player or device that is configured to render digital media so that the user can experience the content that is transferred to media device 218.

In the examples herein, the media content of digital media file 208 may be audio data, video data, still image data, and/or text data. Examples of digital items in a collection may also include static or automated playlists of files or any grouping of files or data. It is to be appreciated and understood that the media content can be embodied on any suitable media, including digital files downloaded to the client computer's memory, and that the specific examples described herein are given to further understanding of the inventive principles. For example, the media content can include, without limitation, specially encoded media content in the form of an encoded media file (e.g., media content encoded in Microsoft® Windows Media™ format using the Microsoft® Windows Media™ Player program by Microsoft Corporation of Redmond, Wash.).

FIG. 2 illustrates an exemplary source-target synchronization scenario. In the depicted scenario, computer 204 comprises a source device and portable device 218 comprises a target device. In the illustrated embodiment, computer 204 executes a target device storage sync manager program module embodied on one or more processor-readable media (such as a computer storage or memory 212) and implemented as part of multimedia software product, an operating system, or a dedicated multimedia appliance.

The exemplary target device storage sync manager provides a user-configurable model for facilitating automatic transfer of all or a subset of a user's digital collection to the target, portable device 218, from the source, computer 204. In FIG. 2, a transfer interface 220 couples target device 218 to source computer 204. This physical interface may be wired or wireless. Examples of a wired interface include USB, IEEE 1394, IEEE1284 (“parallel” connection), RS-232 Serial connection, and/or Ethernet, Token Ring, and similar networks. Examples of a wireless interface include Bluetooth; Infra-Red (IR); 802.11a, b, or g; GPRS, CDMA, EVDO, EDGE, and other related wireless telephony data-transmission standards. In some implementations, the interface 220 may provide for data transfer over a short distance (e.g., measured in a few feet) or over a long distance (e.g., measured in miles).

Generally, selected items are transferred from the source device, computer 204, to the target device, portable client 218, via the interface 220. Transferring files may occur item-by-item until the collection is exhausted or the storage capacity of the target device is consumed. The transfer from computer 204 to device 218 (and vice versa) may be called “synchronization” (or simply “sync”). As the collection on the source device changes (e.g., items removed, items added, and/or item priority changes), the subset of the collection which is stored on the target device changes with each synchronization. Indeed, if storage space on device 218 is limited, items may be removed from the target device during synchronization and replaced with new items from the collection which have higher priority.

Aspects of the present invention involve synchronization and transfer of data to portable media player device 218. Transferring files to a device (i.e., synchronization) has typically been a per-item process where a large batch of content is selected, and one-by-one each file is transferred. As described above, conventional UI displays involve showing the progress of each file individually and, if there is an error, showing the appropriate error or message alongside the files to indicate the status of the transfer. In one embodiment of the present invention, MPA 206 groups status information for items that have been or are waiting to be processed and provides the status information, on a per-group basis, to the user via UI 214. Each file is placed under a common entry according to the status of the transfer. The user may view individual items for any particular “bucket,” group, node, or category by expanding the contents of the bucket.

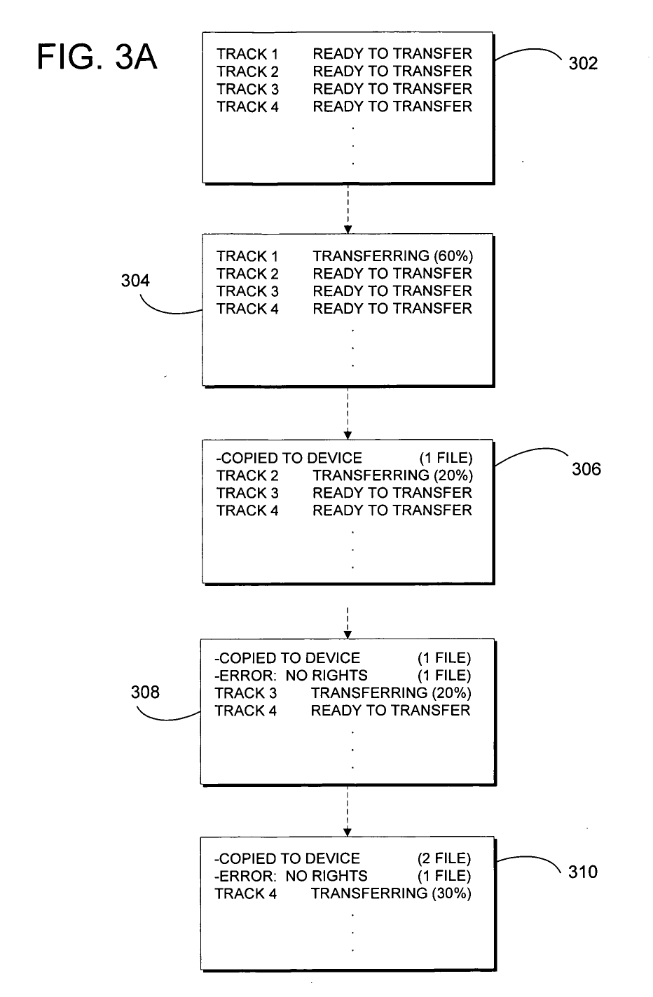

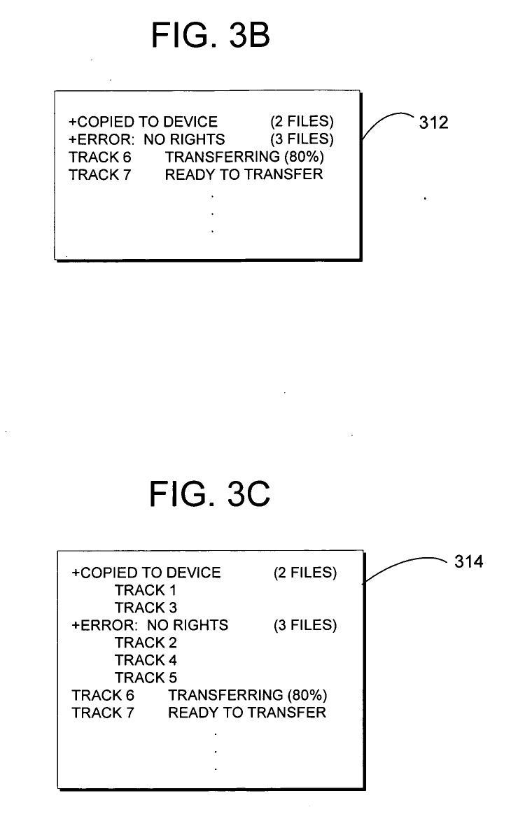

FIG. 3A, FIG. 3B, and FIG. 3C illustrate exemplary coalesced per-file device synchronization status embodying aspects of the invention. In FIG. 3A, a flat list or array of every file to be transferred, which exemplifies an initial state, is shown at 302. File transfer to device 218 begins at 304. At first, as Track 1 (or other file) begins to transfer, the UI at 304 only provides status information for Track 1 (e.g., “Transferring (60%)”). Once the action on Track 1 has been terminated (either successfully or unsuccessfully), the status information is rolled up into a group, or bucket. At 306, the UI indicates status information such as “Copied to Device (1 File).” In other words, the invention adds a sub-list and moves the Track 1 information to the newly added sub-list. The remaining track information remains in its initial state (i.e., a flat array showing “Ready to Transfer”).

If the transfer of Track 2 fails for some reason, the invention at 308 adds a new bucket to the list (e.g., “Error: No Rights”) and moves the Track 2 status information into the new bucket. Whether subsequent transfers succeed or fail determines which bucket gets the status information. The end result is a summary at 310. For example, the summary is a root base list (e.g., an array of child lists) and items that have not been acted upon. The array of lists matches errors that have been encountered and those items that have not acted upon.

Moreover, the summary approach may be extended to categorize the unprocessed items in a bucket (e.g., “Ready to Transfer (6 Files)”). It is further contemplated to only list the errors and to not list the successful transfers.

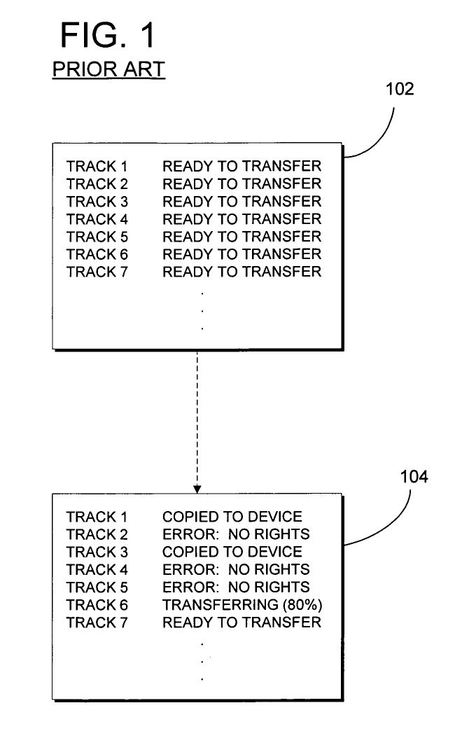

FIG. 3B illustrates a summary 312 corresponding to the flat array information of FIG. 1. In one embodiment, the contracted summary can be expanded as shown in FIG. 3C at 314 in a manner similar to an expandable tree structure. In other words, one aspect of the invention provides a list with grouping headers that can be expanded or contracted.

Advantageously, embodiments of the present invention organize or categorize status information for files that were transferred to device 218 (or had a transfer attempted for them) into buckets representing what actually happened. One aspect of the invention provides roll-up counts as the items are processed and each status event occurs. This has the distinct advantage of cutting down on the noise that the user is presented with upon completion of a synchronization. Then, by expanding the contents of the bucket (i.e., drilling down on the status information) as shown at 314, the user can learn about the status of individual items. Because transferring thousands of files may yield only a handful of buckets, or groups, of status indicators, the user can get an overall sense of how the transfer went without becoming bogged down unnecessarily in detail. And if all of the files successfully transferred to device 218, the user would not have to scroll through all of the individual per-file status indicators to determine this.

The bucket aspect of the invention also enables the user to manage and “bulk fix” content having similar problems. For example, the user can, in a single action, delete all failed content that was not found, such as when content was previously deleted from source computer 204. In another example, the user can, in a single action, renew a series of licenses that failed for a larger group of tracks. Many of the typical failure cases of device transfer can be exposed as simple buckets that a user can act upon, rather than associating each error with each piece of content. As such, the user is no longer required to hunt and peck for the problem content and then attempt to repair the error individually for each media file. Grouping like errors in this manner enables correcting the errors collectively, which leads to a faster resolution.

Additionally, this type of reporting provides an opportunity for content and service providers to offer services. For example, when a user attempts to transfer content that is not licensed for transfer, the error message may include a link for buying additional copies or upgrading the user's service level.

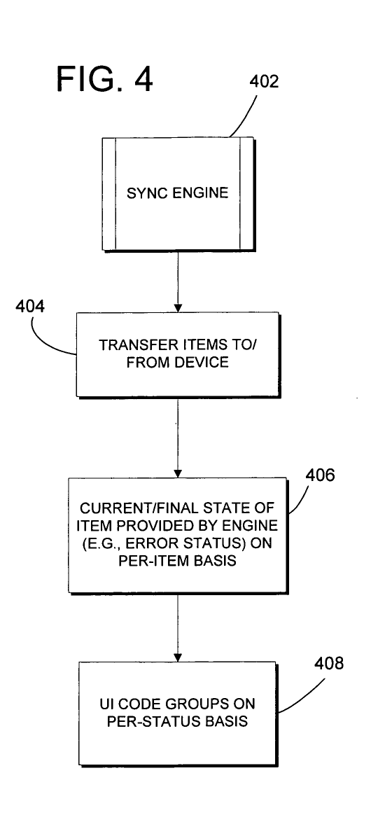

Referring now to FIG. 4, an exemplary flow diagram illustrates aspects of a synchronization algorithm according to the present invention. In one embodiment, computer 204 executes a sync engine at 402. For example, computer 204 first examines device 218 and uses a quick heuristic (e.g., available free space) to detect whether or not the contents of device 218 have changed since the device was last seen by computer 204. If not, the record of what “should” be on device 218 in a local data store can be assumed to be correct, and determination of what files, if any, need to be transferred during this synchronization can go ahead without direct (and potentially time consuming) verification that each file that “should” be on the device is actually there. On the other hand, if the contents of device 218 have changed, computer 204 needs to determine what the actual contents of device 218 are. It accomplishes this by loading a record of what “should” be on device 218 from a local data store. Computer 204, in this example, then examines each file that “should” be on device 218 to see if it is actually present as part of the sync engine. If a particular media file should be stored on device 218 but it is not present, then computer 204 sets the local data store's notion of what device 218 should hold if the file had been on the device properly. Computer 204 performs additional cleanup operations in preparation of beginning the transfer of files.

At reference character 404 of FIG. 4, upon building an ordered list of items to be moved or copied to device 218 and/or deleted from device 218, computer 204 begins the transfer process. According to aspects of the invention, computer 204 executes code (e.g., intertwined with the sync engine code) to take the current/final state of each item in the transfer list on a per-item basis at 406 and then group the information at 408. A user interface embodying aspects of the invention shows rolled-up status information. The information may first be shown in list form and then as each item in the list is acted upon (e.g., copied to device 218), the status information is moved into the appropriate bucket.

Aspects of the present invention lead to a vast improvement in the user experience when dealing with a large set of content to be operated on. As storage capacities of devices grown, and content becomes easier for consumers to purchase or locate, the level of detail that has traditionally been associated with reporting synchronization status will quickly become ineffective without the benefit of the invention.

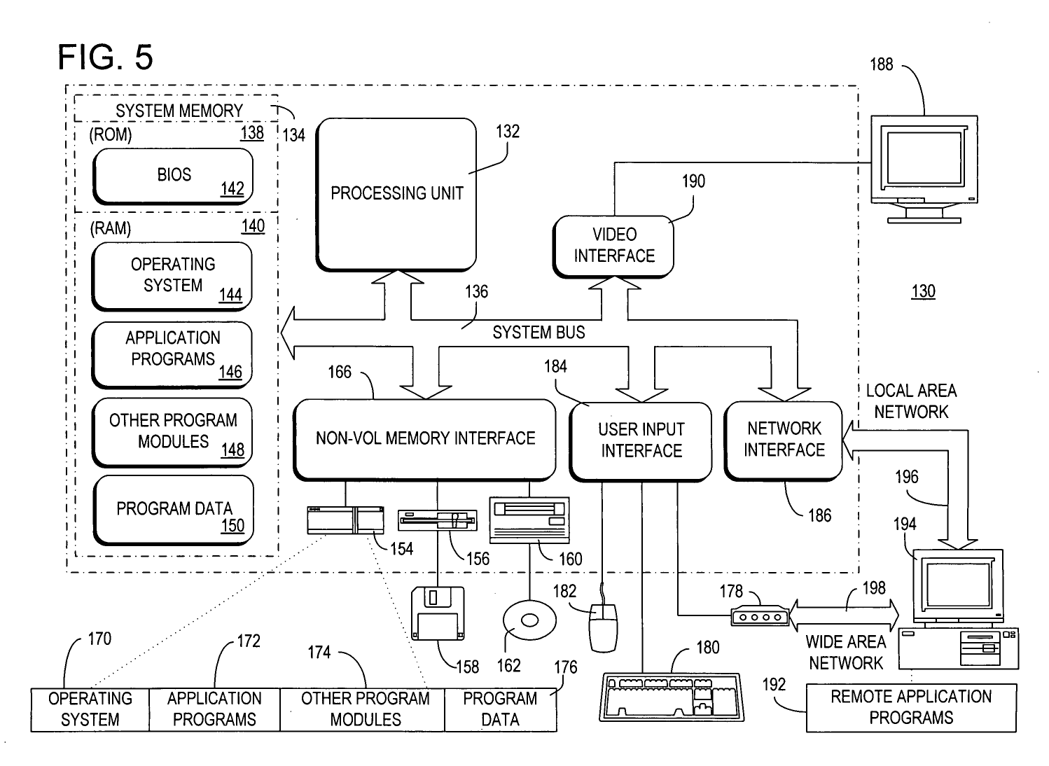

FIG. 5 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), including the basic routines that help to transfer information between elements within computer 130, such as during start-up, is typically stored in ROM 138. RAM 140 typically includes data and/or program modules that are immediately accessible to and/or presently being operated on by processing unit 132. By way of example, and not limitation, FIG. 5 illustrates operating system 144, application programs 146, other program modules 148, and program data 150.

The computer 130 may also include other removable/non-removable, volatile/nonvolatile computer storage media. For example, FIG. 5 illustrates a hard disk drive 154 that reads from or writes to non-removable, nonvolatile magnetic media. FIG. 5 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 5, provide storage of computer readable instructions, data structures, program modules and other data for the computer 130. In FIG. 5, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 5 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 5 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. Embodiments of the invention described herein include these and other various types of computer-readable storage media when such media include instructions or programs for implementing the steps described below in conjunction with a microprocessor or other data processor. One embodiment of the invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, one embodiment of the invention is operational with numerous other general purpose or special purpose computing system environments or configurations. The computing system environment is not intended to suggest any limitation as to the scope of use or functionality of embodiments of the invention. Moreover, the computing system environment should not be interpreted as having any dependency or requirement relating to any one or combination of components illustrated in the exemplary operating environment. Examples of well known computing systems, environments, and/or configurations that may be suitable for use with the embodiments of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Embodiments of the invention may also be practiced in distributed computing environments where tasks are performed by remote processing devices that are linked through a communications network. In a distributed computing environment, program modules may be located on both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In FIG. 2, the source device is depicted as a desktop personal computer 204. However, in other implementations, the source device may be a portable laptop computer, another portable device, a mini-computer, a mainframe computer, a server, a storage system, a dedicated digital appliance, or another device having a storage sub-system configured to store a collection of digital data items. Furthermore, the implemented source device 204 is configured to copy all or some of its collection of digital data items to a coupled device.

In FIG. 2, the target device is depicted as a portable device 218, such as a media player. However, in other implementations, the target device may be a non-portable computer, a portable laptop computer, another portable device, a mini-computer, a mainframe computer, a server, a storage system, a dedicated digital appliance, or another device having a storage sub-system configured to store a collection of digital data items. Furthermore, the implemented target device 218 is configured to receive a copy of all or some of a coupled source device's collection of digital data items.

Herein, “digital items” of a digital collection is any type of independently addressable unit of digital data which is typically stored within a computer memory or storage system. Examples of such a “digital item” include (but are not limited to): music, image, video, text documents, hypertext document, documents of any format, applications, spreadsheets, graphics, playlists, and data. A digital item may include a collection of other items.

The order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of embodiments of the invention, it is intended that all matter contained in the above description and shown in the accompanying drawings shall be interpreted as illustrative and not in a limiting sense.

What is claimed is:

1. A method of reporting status information in a user interface, said status information relating to a synchronization between a source device and a target device coupled thereto, said synchronization including one or more operations performed on each of a plurality of selected digital files being synchronized, said method comprising:
defining one or more categories of status information in connection with the synchronization operations performed on the digital files;
upon termination of a synchronization operation performed on one of the digital files, categorizing per-file status information for the terminated synchronization operation in one of the defined categories; and
displaying the defined categories having per-file status information categorized therein with a summary of the per-file status information.

2. The method of claim 1, further comprising displaying a base list in the user interface, said base list comprising per-file status information for each of the digital files being synchronized.

3. The method of claim 2, further comprising removing, from the base list, the per-file status information for terminated synchronization operations.

4. The method of claim 2, further comprising updating the per-file status information in the base list upon termination of the synchronization operations performed on the digital files before categorizing the per-file status information.

5. The method of claim 2, wherein categorizing per-file status information comprises creating a sub-list to the base list and moving the per-file status information for the terminated synchronization operation from the base list to the sub-list.

6. The method of claim 1, wherein each of the defined categories of status information comprises an expandable node having a plurality of levels and wherein displaying the defined categories comprises displaying the summary of the per-file status information when the node is collapsed and displaying the per-file status information when the node is expanded.

7. The method of claim 1, further comprising grouping the digital files according to the defined categories of status information and collectively managing the digital files based on the grouping.

8. The method of claim 1, wherein the synchronization operations comprise one or more of the following: moving at least one of the digital files from the source device to the target device; copying at least one of the digital files from the source device to the target device; and deleting at least one of the digital files from either the source device or the target device or both.

9. The method of claim 1, wherein the categories of status information comprise one or more of the following: Queued for Transfer; Transferring; Transcoding; Error; Insufficient Space on Device; and Removed from Device.

10. The method of claim 1, wherein the digital files are selected from a group of digital content consisting of audio, image, video, and text.

11. The method of claim 1, wherein one or more computer-readable media have computer-executable instructions for performing the method recited in claim 1.

12. In a computer system having a display and a selection device, a method of reporting status information in a user interface presented on the computer system display, said status information relating to a synchronization between a source device and a target device coupled thereto, said synchronization including one or more operations performed on each of a plurality of selected digital files being synchronized, said method comprising:
defining one or more categories of status information in connection with the synchronization operations performed on the digital files;
upon termination of a synchronization operation performed on one of the digital files, categorizing per-file status information for the terminated synchronization operation in one of the defined categories;
displaying an expandable node corresponding to each of the defined categories of status information that have per-file status information categorized therein, said node being responsive to the selection device for displaying the summary of the per-file status information when the node is collapsed and for displaying the per-file status information when the node is expanded.

13. The method of claim 12, further comprising displaying a base list in the user interface, said base list comprising per-file status information for each of the digital files being synchronized.

14. The method of claim 13, further comprising removing, from the base list, the per-file status information for terminated synchronization operations.

15. The method of claim 13, further comprising updating the per-file status information in the base list upon termination of the synchronization operations performed on the digital files before categorizing the per-file status information.

16. The method of claim 13, wherein categorizing per-file status information comprises creating a sub-list to the base list and moving the per-file status information for the terminated synchronization operation from the base list to the sub-list, said sub-list corresponding to the expandable node.

17. The method of claim 12, further comprising grouping the digital files according to the defined categories of status information and collectively managing the digital files based on the grouping.

18. The method of claim 12, wherein the categories of status information comprise one or more of the following: Queued for Transfer; Transferring; Transcoding; Error; Insufficient Space on Device; and Removed from Device.

19. The method of claim 12, wherein one or more computer-readable media have computer-executable instructions for performing the method recited in claim 12.

20. A method of managing a synchronization between a source device and a target device coupled thereto, said synchronization including one or more operations performed on each of a plurality of selected digital files being synchronized, said method comprising:
defining one or more categories of status information in connection with the synchronization operations performed on the digital files;
upon termination of a synchronization operation performed on one of the digital files, categorizing per-file status information for the terminated synchronization operation in one of the defined categories;
grouping the digital files according to the defined categories of status information; and
collectively managing the digital files based on the grouping.
